(19) United States
(12) Patent Application Publication
(10) Pub. No.: US 2022/0325910 A1
(43) Pub. Date: Oct. 13, 2022

(54) System and Method for Indoor Air Quality Purification

(71) Applicant: Ferrin Daniel Rivera, Harbor City, CA (US)

(72) Inventor: Ferrin Daniel Rivera, Harbor City, CA (US)

(21) Appl. No.: 17/717,349

(22) Filed: Apr. 11, 2022

Related U.S. Application Data
(60) Provisional application No. 63/172,995, filed on Apr. 9, 2021.

(51) Int. Cl. F24F 8/22; F24F 11/58; F24F 11/52

(52) U.S. Cl. CPC F24F 8/22; F24F 11/58; F24F 11/52; F24F 2110/64

(57) ABSTRACT

The present disclosure generally relates to an air purification system and a method for providing real time air quality ratings. The air purification system may be installed in a building according to different levels of air purification effectiveness. The more effective the system installed, the higher the rating it can achieve. In some embodiments, real time monitoring may detect when the air quality falls below an acceptable level and triggers the air purifier to improve the air quality.

### TECHNICAL FIELD

The present disclosure is directed to testing and measuring, and more particularly, to a system and method for indoor air quality purification.

### BACKGROUND OF THE DISCLOSURE

Commercial air conditioning systems have far worse indoor air quality than their residential counterparts. One main difference is that all commercial AC systems have a fresh air intake. The intake may suck in gas powered automobile fumes, diesel powered big rig truck fumes, or LPG or natural gas powered forklift exhaust. The commercial AC systems may sometimes receive the smell from chemicals in the environment, for example, commercial soaps and other cleaners, and paints and such. Technicians performing AC system maintenance may find soot and carbon filled systems and at times live or dead rodents, birds, snakes within the air stream.

The second major difference is that commercial systems on average, use a very low MERV 1 through MERV 4 rated filter. Low MERV rated filter are installed because:

Cost. Commercial building owners and tenants are typically more concerned about reducing overhead costs than keeping clean air quality.

Utility companies may recommend very low MERV rated filters that maximize air flow and in the short term keep energy costs down. Yet a low rated MERV filter will in the long run allow fine dust to pass through the filters media and clog the indoor coil and develop a film on the curves of the indoor fan squirrel cage blower. This reduces the (CFM) cubic feet per minute of airflow the fan is designed to blow. Plus, the clogging of the indoor coil minimizes the performance (true EER) rating of the equipment.

Many hotel room and lobby room systems may have mold filled equipment. Guests may commonly have a sneeze attack when turning on the room AC system. The cause is usually the air filter which may be completely clogged.

However, it is a total envelope air purification system design that is needed in order to get grade A clean air inside buildings. These systems should include up to 6 stages of air purification which includes outdoor air ventilation with the ability to keep a positive pressure within the conditioned space.

Those stages include a built in exhaust that dumps out unwanted conditioned air towards the outdoors that simultaneously creates a negative pressure envelope and can be used as a quarantine room to eliminate any cross contamination between rooms and thus keeping it self-contained.

Preferably these air purification systems should also have the ability to turn on and off independently from the buildings HVAC system so that wet coil created biological growth that may be lingering inside the HVAC duct work does not get blown around as the air is trying to get purified, which would defeat the purpose.

Furthermore, an effective air purifier would be best if it is controlled by an indoor air quality monitor that has the ability to turn on any stage air purifier as the need arises.

The exemplary disclosed system and method of the present disclosure is directed to overcoming one or more of the shortcomings set forth above and/or other deficiencies in existing technology.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a perspective elevational view of an air purification system showing internal parts in accordance with an exemplary embodiment of the subject disclosure;

FIG. 2 is a perspective elevational view of the air purification system of FIG. 1;

FIG. 3 is a perspective elevational view of the air purification system of FIG. 1 flipped upside down and rotated;

FIG. 4 is a perspective front elevational view of the air purification system of FIG. 1;

FIGS. 5-9 are screenshots of a real time indoor air quality index wall mount digital display and dashboard showing various grade levels of a current measured air quality in an environment in accordance with embodiments of the subject disclosure;

FIG. 10 is a schematic illustration of an exemplary computing device, in accordance with at least some exemplary embodiments of the present disclosure;

FIG. 11 is a schematic illustration of an exemplary network, in accordance with at least some exemplary embodiments of the present disclosure; and

FIG. 12 is a schematic illustration of an exemplary network, in accordance with at least some exemplary embodiments of the present disclosure.

### DETAILED DESCRIPTION

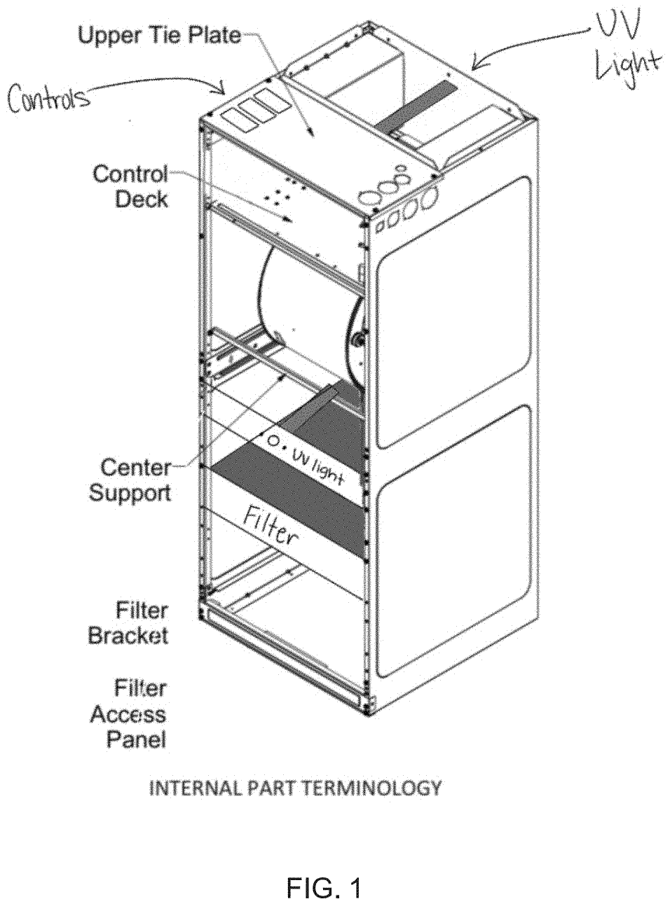

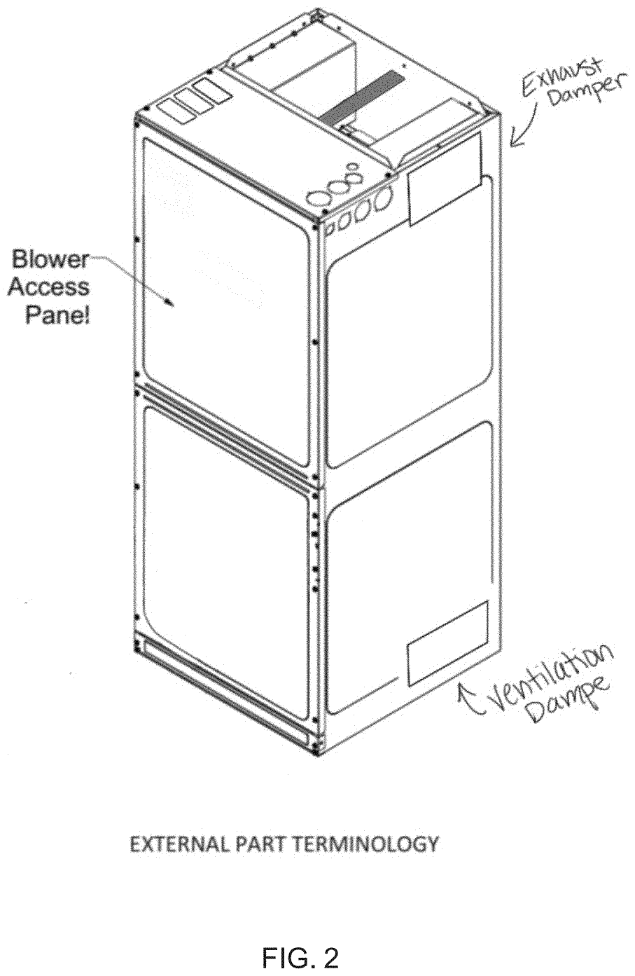

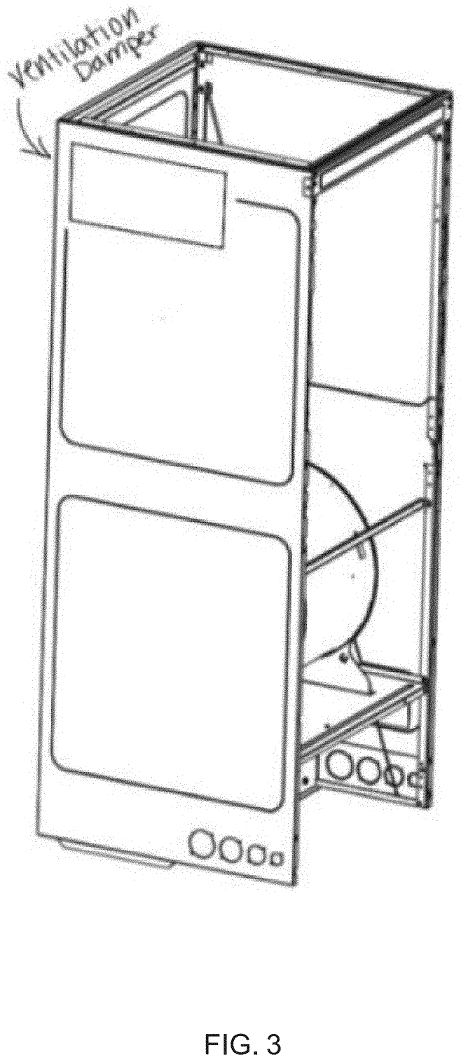

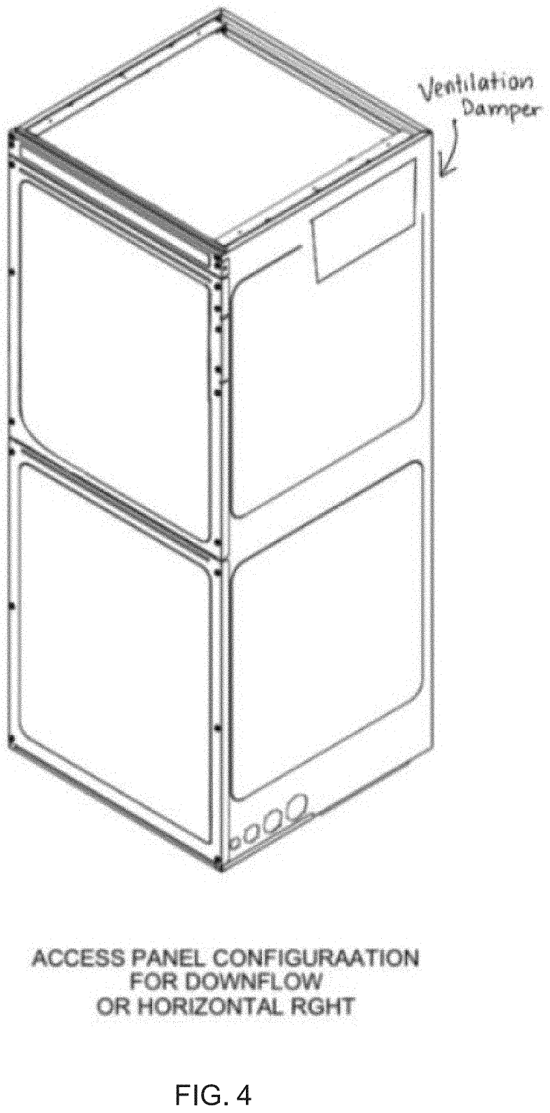

In at least some exemplary embodiments, an air purification system with real time monitoring is disclosed. An air purification system is shown in FIGS. 1-4 according to embodiments. The air purification system may be a multi positional 6 stage central air purification system that traps particles and allergens, removes chemical gases and odors, sterilizes germs and infectious agents and ventilates fresh air into the building through the operation of 6 switches or from the command of an indoor air quality control sensor. In an exemplary embodiment, the air purification system may include: a Merv 16 Charcoal air filter; 2 UV air scrubbers; a ventilation system; an exhaust system and a Wifi enabled system and control.

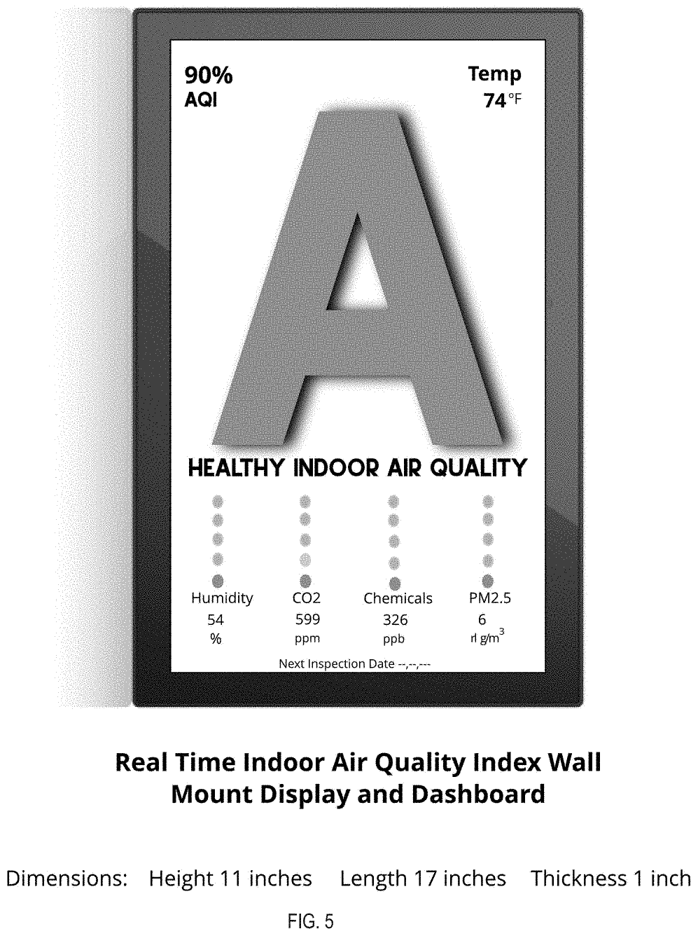

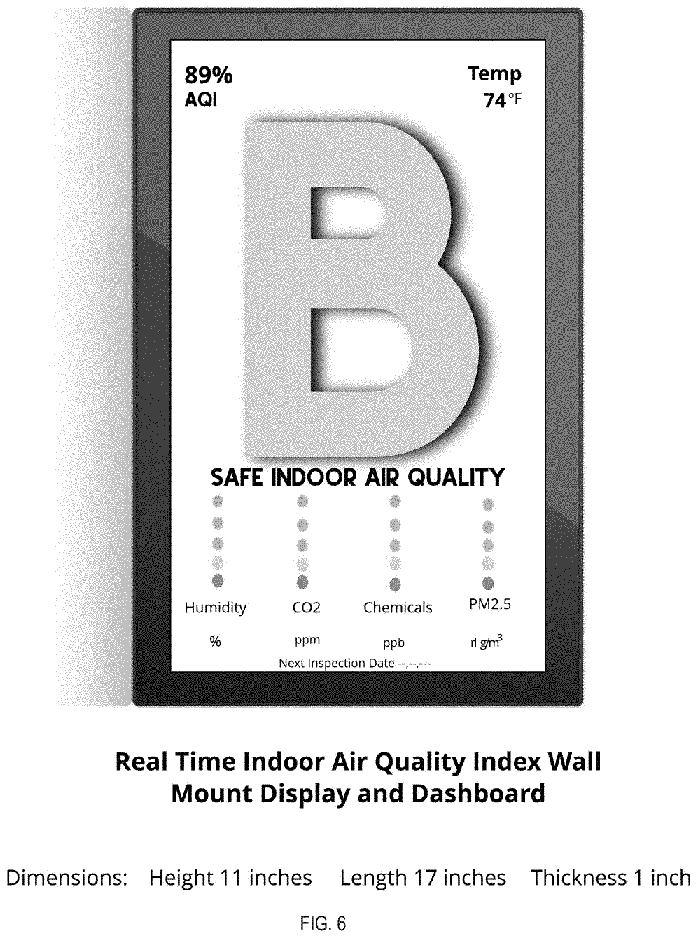

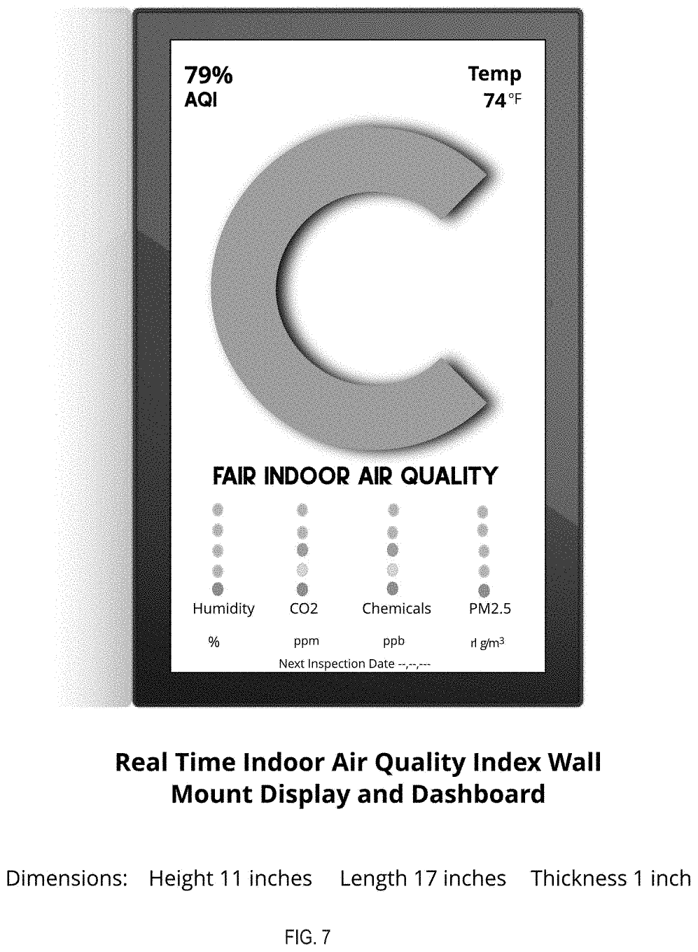

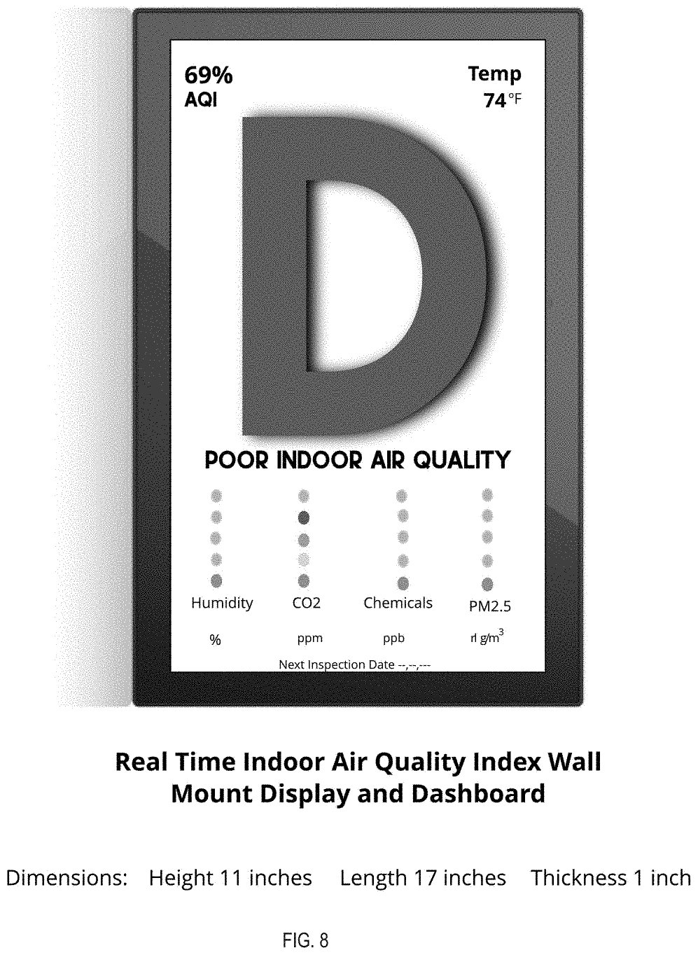

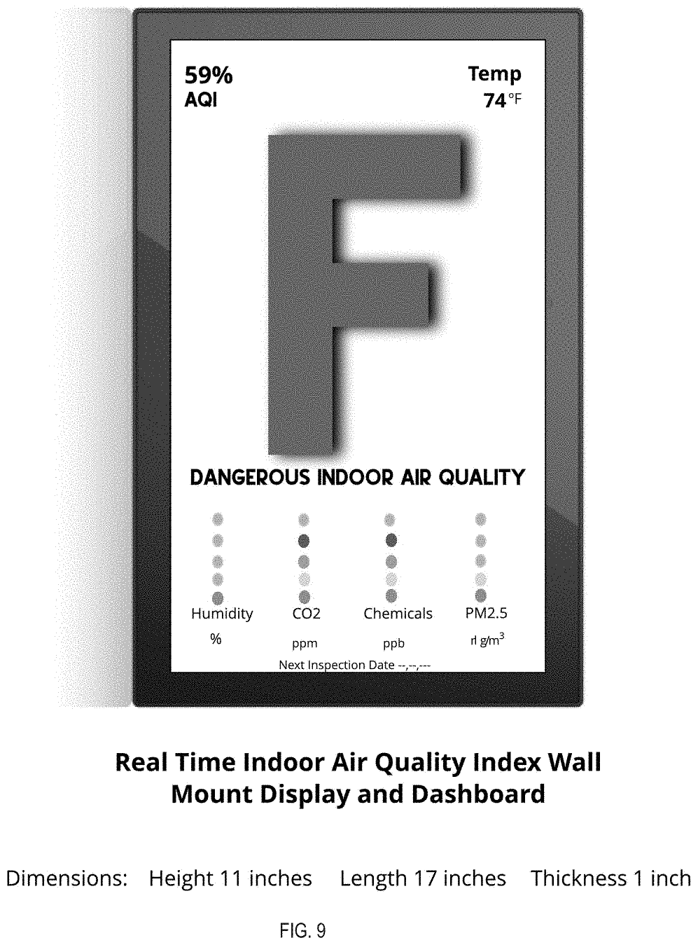

In some embodiments, a monitoring system is integrated which measures current levels of air quality for factors which may include for example, temperature, humidity, carbon dioxide, carbon monoxide, chemicals (which may cause odor or an adverse reaction to those people present), and particulate matter PM 2.5 and PM 10 and Radon. In some embodiments, the monitoring system may trigger automatic operation of the air purification system to lower one or more of the measured environmental factors. FIGS. 5-9 show a digital display which may be in communication with the monitoring system. The digital display may show real time measurements of the factors. In some embodiments, the current level of factors may be displayed by a rating (A, B, C, D, or F), which provides users a convenient summary of the current air quality conditions. In some embodiments, the air purification system may include a manual control system to operate. This may be helpful when a user sees that the air quality index displayed may be too low thus prompting the user to operate the air purification system until a satisfactory rating is achieved.

In an exemplary embodiment, the air purification system unit dimensions may be approximately 53 7/16″ high×23″ wide×21″ depth. The system may include a 208/230V, with neutral 1 Phase, 60 Hz 15 Amp circuit; a 1800/1350 CFM-11⅝″ Blower diameter and 10⅝″ width, 1 HP ECM motor 6.9 Amps, a MERV 16 carbon filter with the ability to capture particulate down to:

PSE (um) 0.30-1.0 to 95.2%

PSE (um) 1.0-3.0 to 99.1%

PSE (um) 3.0-10.0 to 99.9%

The system may include in some embodiments a UVC air scrubber with carbon catalyst. The UV operating output wavelengths may range from about 1-400 nm. As may be appreciated, UVC light with activated carbon cells reduces airborne odors, mold, germs, and allergens.

Some embodiments may include an electronic zone damper. Power close, power open 24V (14″×8″ damper size.) The damper may open on the call for ventilation automatically or manually. For example, in a system with automatic air purification based on the air quality dropping below a certain level, the damper may automatically be opened.

Some embodiments may include another electronic zone damper. Power close, power open 24V (10″×8″ damper size.) The damper may open on the call for exhaust automatically or manually. For example, in a system with automatic air purification based on the air quality dropping below a certain level, the damper may automatically be opened.

The air purifier system may have a custom fabricated and designed electrical control system with custom fabricated electrical components to make it operate in stages and can and should be ducted.

All components and controls have been designed to fit in one sleek looking box that is installed hidden above ceilings and can cover an area of up to 2500 square feet with the proper static pressure of 0.5 inches of water column.

Installation Procedures.

Air purifiers may be installed in multiple positions, for example, upflow, downflow, horizontal right or left. One example of a preferred installation location is above drop ceilings or above ceiling height and out of sight. The unit should be ducted for proper distribution and to reduce operating noise levels. The return size may be for example, 20″ round duct if installed for 1 large room. Or it may need to be ducted into every office to increase systems ability to purify the air.

Supply Purified Air.

Purified air may be ducted to strategic locations for enhanced air purification results.

Operation:

Stage 1. Turn stage 1 on and the fan turns on in low speed and it starts purifying the air. Stage 1 is designed to work for filtering particulate matter PM10-1.0 ug/m3 or greater when used with a monitor.

Stage 2. Turn stage 2 on and the fan turns on at high speed. Stage 2 is designed to work for filtering greater levels of particulate matter PM10-1.0 ug/m3 or greater when used with a monitor.

Stage 3. Turn stage 3 on and the upstream UVC system turns on. Designed to purify VOC “volatile organic compounds”. Measured in (PPB) 0-1000 or greater when used with a monitor.

Stage 4. Turn stage 4 on and the downstream UVC system turns on. Designed to work for VOC purification. Measured in (PPB) 1500-8332 or greater when used with a monitor.

Stage 5. Turn stage 5 on and the outdoor fresh air ventilator opens and the fans starts to pull in fresh air from an outdoor source. Stage 5 is designed for CO2 dilution. Measured in PPM 0-2500 or greater. When used with a monitor.

Stage 6. Turn stage 6 on and the exhaust dampers opens and begins to dump air back out into the atmosphere. Stage 6 is designed for larger quantities of all contaminant dilution. Measured according to contaminant/polutatnt. When used with a monitor.

Some embodiments may include a certification process based on the real time monitoring aspect. The certification ratings may be displayed as decals or digitally. A 5 step certification process would merit an “A” rating. A 4 step certification process that would merit a “B” rating. A 3 step certification process that would merit an “C” rating. A “NP” rating notifies patrons that there is No Protection for air quality in this building and enter at own risk.

5 Step process meriting a Grade A rating includes the installation of:

1. Merv 14 (or better than the surgery room grade) particulate and allergen reducing media filter.

2. UV light for biological organism sterilization and growth reduction and spread prevention.

3. Activated carbon for VOC's and odor reduction.

4. Carbon filtered fresh air entry for smoke and wild fire ash pollution prevention.

5. Positive air envelope system design which dilutes contaminants and prevents cross contamination from conditioned and non-conditioned spaces.

4 Step process meriting a Grade B rating includes the installation of:

1. Merv 13 or better, particulate and allergen reducing media filter;

2. UV light for biological organism sterilization and growth reduction and spread prevention.

3. Activated carbon for VOC's and odor reduction.

4. Carbon filtered fresh air entry for smoke and wild fire ash pollution prevention.

3 Step process meriting a Grade C rating includes the installation of:

1. Merv 13 or better, particulate and allergen reducing media filter.

2. UV light for biological organism sterilization and growth reduction and spread prevention.

3. Activated carbon for VOC's and odor reduction.

NP rating may be anything less than the following 3 steps will be labelled as a NO PROTECTION rating (NP) for the following reason:

Media filters alone cannot reduce the spread of biological organisms.

UV Lights without Merv 13 filters develop films that reduce their ability to sterilize organism rapidly.

Activated carbon filters cannot be activated without UV lights.

The window decal dimensions may be 8.5″×11″ with front side adhesive to be placed on the inside of store front window facing outwards. The decal clearly states, “Indoor Air Quality” at the very top. Second sentence may state “Air Purification Rating” on the second sentence from the top. In the middle is a very large font “A” or “B” or “C” or “NP” for those without air purifiers. At the lower end of the decal is a small line that says, “Certification Number” with a space to fill in. Below that is an “Establishment Name” with space to fill in the name. This verifies that the rating was provided to the appropriate business. The next line states “Date issued” with space to fill in. The following line states. “Renewal date” with space to place date. At the very bottom there is a small font line that states, “For Germs and infectious agents, particles and allergens, chemical gases and odor removal.”

The full description of the invention is an Indoor air quality certification process that will establish a new normal to help reduce the spread of infectious disease and other respiratory health related issues.

The way this process may work will be by the following methods.

Business, schools, Public or private will apply for an air quality assessment.

An investment proposal will be sent to applicants.

A Contract/Agreement will be established and the installation date of the air purification system will be booked.

According to the Agreement a Grade A, B or C type system will be selected. Or Model I system is agreed to be installed.

The installation will be completed and verified by our Quality assurance team and certifier.

The window decal/digital display will be issued and placed on the window with business name and renewal date.

Before the renewal date is expired a service technician will service the air purification system. After purifier service is complete a certified technician will verify that the system has met standards.

Entity will continue to promote a safe indoor air quality environment to patrons and will keep or improve rating.

Businesses that do not keep current with A, B, C rating will be given a NP after expiration and will be encouraged to renew in an effort to protect employees and patrons.

As described above, some embodiments may use digital displays and/or wireless monitoring and communication. A processor may make determinations of whether current readings exceed or fall below air quality measurement thresholds. The processor may be part of a computing device which controls the display of the current air quality rating. In some embodiments, the system and method may be provided as a remotely hosted service. Measurements may be broadcasted to a remote computing device which may control the operation of the local air purification system remotely. Similarly, the real time rating may be adjusted by the remote computing device.

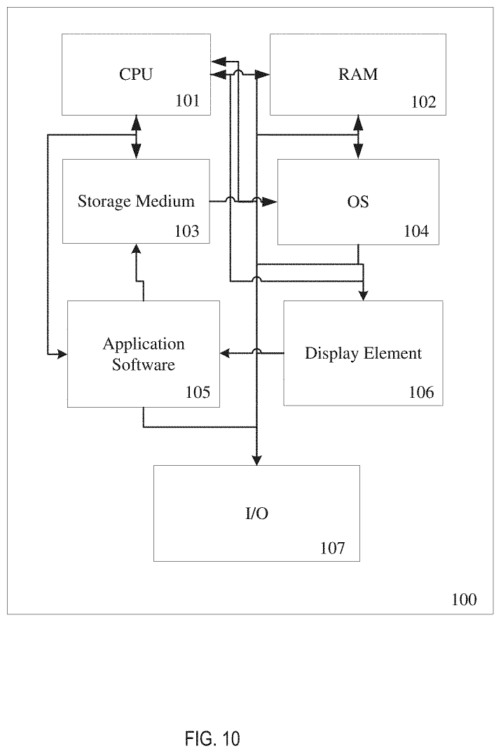

An illustrative representation of a computing device appropriate for use with embodiments of the system of the present disclosure is shown in FIG. 10. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

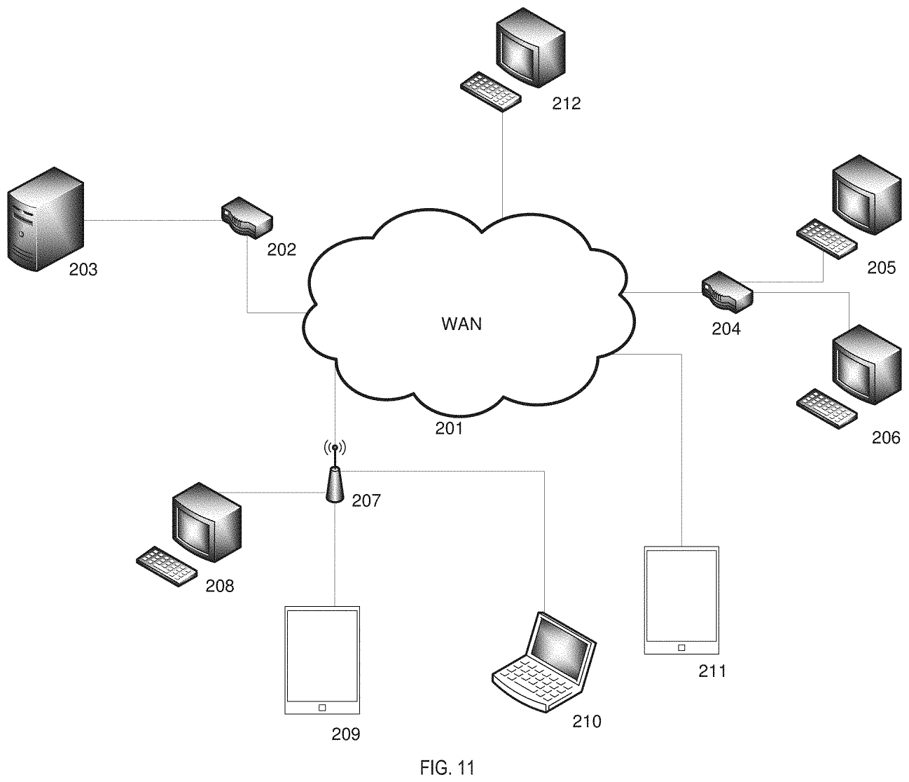

Various examples of such general-purpose multi-unit computer networks suitable for embodiments of the disclosure, their typical configuration and many standardized communication links are well known to one skilled in the art, as explained in more detail and illustrated by FIG. 11, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 11, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 11, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G, 5G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

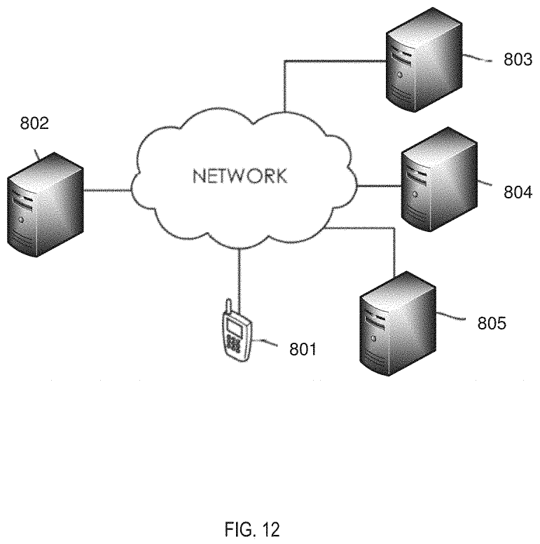

Turning now to FIG. 12, a continued schematic overview of a cloud-based system in accordance with an embodiment of the present invention is shown. In FIG. 12, the cloud-based system is shown as it may interact with users and other third party networks or APIs (e.g., APIs associated with the exemplary disclosed E-Ink displays). For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional data services 805 or any combination thereof. Additionally, application server 802 may be able to enhance or otherwise provide additional services to an external content provider API/website or other third party system 803, a constituent data service 804, one or more additional data services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. An air purification system with real time monitoring, comprising a multi positional six stage central air purification system configured to trap particles and allergens, remove chemical gases and odors, sterilize germs and infectious agents, and ventilate fresh air, wherein the air purification system is configured to operate via six switches that correspond to the six stages or via one or more commands from an indoor air quality control sensor.

2. The air purification system of claim 1, further comprising one or more fans, a Merv 16 Charcoal air filter, at least two ultraviolet (UV) air scrubbers, a ventilation system, an exhaust system, and a Wi-fi enabled system and control.

3. The air purification system of claim 1, further comprising an integrated monitoring system configured to measure current levels of air quality for environmental factors comprising temperature, humidity, carbon dioxide, carbon monoxide, chemicals, particulate matter, and/or Radon.

4. The air purification system of claim 3, wherein the particulate matter comprises PM 2.5 and PM 10.

5. The air purification system of claim 3, wherein the monitoring system is configured to trigger automatic operation of the air purification system to lower the current level of one or more of the measured environmental factors.

6. The air purification system of claim 5, further comprising a digital display in communication with the monitoring system and configured to show real time measurements of the environmental factors.

7. The air purification system of claim 6, further comprising a manual control system.

8. The air purification system of claim 7, further comprising one or more short-wave ultraviolet (UVC) air scrubbers comprising carbon catalysts.

9. The air purification system of claim 8, further comprising one or more exhaust dampers.

10. A system for automated air purification control and real time air quality display comprising the air purification system of claim 9 and a computing device comprising one or more processing units.

11. The system of claim 10, wherein the computing device is a remote computing device configured to control the operation of the local air purification system remotely.

12. A method for automated air purification control and real time air quality display comprising operating the air purification system of claim 9 to initiate one or more stages comprising:
a) a stage one in which the fan turns on at low speed;
b) a stage two in which the fan turns on at high speed;
c) a stage three in which an upstream UVC air scrubber turns on;
d) a stage 4 in which a downstream UVC air scrubber turns on;
e) a stage 5 in which an outdoor fresh air ventilator opens; and
f) a stage 6 in which the one or more exhaust dampers open.
